(19) United States
(12) Patent Application Publication
(10) Pub. No.: US 2026/0249980 A1
(43) Pub. Date: Aug. 27, 2026

(54) METHOD AND AVIONICS DEVICE FOR CONTROLLING THE PITCH ANGLE OF A FAN OR PROPELLER OF AN AIRCRAFT POWERTRAIN

(71) Applicant: AIRBUS OPERATIONS SAS, Toulouse (FR)

(72) Inventors: Luc BRUNEL, Toulouse (FR); David BOYER, Toulouse (FR); Quentin-Alexandre FLAMANT-BATI, Toulouse (FR); Nicolas PILON, Toulouse (FR); Carlo NECCI, Toulouse (FR); Laetitia MARRAST, Toulouse (FR)

(73) Assignee: AIRBUS OPERATIONS SAS, Toulouse (FR)

(21) Appl. No.: 19/543,612

(22) Filed: Feb. 18, 2026

(30) Foreign Application Priority Data
Feb. 27, 2025 (FR) 2501992

(51) Int. Cl. B64C 11/30; B64C 13/16; B64D 43/00; F01D 7/00

(52) U.S. Cl. CPC B64C 11/305; B64C 13/16; B64D 43/00; F01D 7/00

(57) ABSTRACT

A method for controlling and limiting a pitch angle of the blades of a fan or propeller of a powertrain of an aircraft aiming to lock said pitch angle of said fan or propeller when an inconsistency in said pitch angle of its blades is detected. The invention further relates to an avionics device configured to implement said method. Advantageously, it is thus possible to limit the risks of undesirable aerodynamic effects in the event of malfunction in the control of the pitch angle of the blades of a propeller or fan of an aircraft powertrain.

### TECHNICAL FIELD

The present invention relates to a method and device for checking the consistency of a pitch angle of the blades of a fan or propeller of an aircraft powertrain, and for limiting this pitch angle if a defect in pitch angle is detected.

### PRIOR ART

Aircraft powertrains comprise fans or propellers that have a variable pitch, thereby making it possible to control the thrust developed by a powertrain through action on the pitch angle of the blades. Each airplane powertrain is controlled by its own control device, said control device being connected to an avionics control device, for example an IMA computer (IMA standing for Integrated Modular Avionics) implementing functions related to the propulsion of the aircraft on board which it is housed. The control device controlling the powertrain regulates the thrust generated by the powertrain based on commands received from the avionics control device, and in particular controls the pitch angle of the blades of the fan or propeller of the powertrain.

Some fan or propeller blade configurations are not acceptable under certain flight conditions, due to the altitude and speed of movement of the aircraft in question, as they may cause undesirable aerodynamic effects for the flight of the aircraft. A pitch angle of the blades of an aircraft powertrain may thus become too small to guarantee the satisfactory aircraft flight conditions, under certain combinations of altitude and speed. This may be the case in the event of malfunction of the control system controlling the pitch angle of the blades of a fan or propeller of an aircraft powertrain.

The situation could be improved.

### SUMMARY OF THE INVENTION

One object of the present invention is to provide a method for limiting a pitch angle of the blades of a fan or propeller of an aircraft powertrain in the event of a powertrain controller device generating an inconsistent blade pitch.

To this end, a method for controlling and limiting a pitch angle of the blades of a fan or propeller of an aircraft powertrain is provided, the method being carried out in an avionics device of the aircraft, the avionics device being housed on board the aircraft, being independent of the powertrain and being connected to a control device for controlling the powertrain driving the fan or propeller, the control device being contained within the powertrain, the method for controlling and limiting comprising:
obtaining first items of information representative of flight conditions of the aircraft, in relation to its external environment, supplied by at least one avionics computer of the aircraft independent of the powertrain, these first items of information comprising at least an altitude and an airspeed of the aircraft,
and the method further comprising:
determining a threshold value for the pitch angle of the blades of the fan or propeller, based on the first items of information, so as to limit the risks of undesirable aerodynamic effects affecting the flight of the aircraft when the aircraft is flying at said altitude at said airspeed,
obtaining an item of information representative of a current pitch angle of the blades of the fan or propeller, and then
sending, to the control device for controlling the powertrain, a control signal when the item of information representative of the current pitch angle of the blades is less than said threshold value, for the purpose of locking the pitch angle of the blades of the fan or propeller, under control by the control device of the powertrain.

It is thus advantageously possible to limit the pitch angle of the blades of a fan or propeller of the aircraft powertrain in the event of malfunction, so as to avoid the appearance of undesirable aerodynamic effects that would otherwise affect the flight of the aircraft. The method is even more advantageous when the signal commanding locking of the pitch angle of the blades of the fan or propeller is generated and dispatched by the avionics device, independently of the powertrain and its control device, depending on said items of information representative of flight conditions of the aircraft in relation to its external environment.

According to one embodiment, the method for controlling and limiting a pitch angle of the blades of a fan or propeller of an aircraft powertrain is such that the generated control signal aims to establish said current pitch angle less than said threshold value, or even said threshold value, as a minimum value of the pitch angle of the blades, the device for controlling the pitch angle of the blades of the powertrain then being free to control a pitch angle of the blades to a pitch angle of the blades of greater value.

According to one embodiment, the method for controlling and limiting a pitch angle of the blades of a fan or propeller of an aircraft powertrain is such that the generated control signal aims to establish said current pitch angle of the blades less than said threshold value, or even said threshold value, as a fixed value to be preserved of the pitch angle of the blades.

According to one embodiment, the avionics device being connected to devices for controlling at least two powertrains of the aircraft, the avionics device is configured to supervise control of the pitch angle of the blades of fans or propellers of said at least two powertrains and not to command the pitch angle of the fans or propellers of all the powertrains of the aircraft to be locked simultaneously.

Another subject of the invention is an avionics device for controlling and limiting a pitch angle of the blades of a fan of an aircraft powertrain or propeller of an aircraft powertrain, the avionics device for controlling and limiting the pitch angle of the blades being designed to be housed on board the aircraft, independent of the powertrain, and comprising electronic circuitry configured to:
obtain first items of information representative of the flight conditions of the aircraft in relation to its external environment, supplied by at least one avionics computer of the aircraft independent of the powertrain, these first items of information comprising at least an altitude and an airspeed of the aircraft,
and the avionics device further comprises electronic circuitry configured to:
determine a threshold value for the pitch angle of the blades of the fan or propeller, based on the first items of information, so as to limit the risks of undesirable aerodynamic effects affecting the flight of the aircraft when the aircraft is flying at said altitude at said airspeed,
obtain an item of information representative of a current pitch angle of the blades of the fan or propeller, and then
send, to the control device for controlling the powertrain, a control signal when said item of information representative of the pitch angle of the blades is less than said threshold value, for the purpose of locking the pitch angle of the blades of the fan or propeller, under control by the control device of the powertrain.

According to one embodiment, the electronic circuitry is configured to supervise control of the pitch angle of the blades of fans or propellers of at least two powertrains of the aircraft and not to command the pitch angle of the fans or propellers of all the powertrains of the aircraft to be locked simultaneously.

Another subject of the invention is an aircraft comprising an avionics device for controlling and limiting a pitch angle of the blades of a fan or propeller of an aircraft powertrain as described above.

Another subject of the invention is a computer program product comprising program code instructions for executing the steps of a method as described above when this program is executed by a processor of an avionics device for controlling and limiting a pitch angle of the blades of a fan or propeller of an aircraft powertrain.

Lastly, another subject of the invention is a data storage medium comprising a computer program product as mentioned above.

### BRIEF DESCRIPTION OF THE DRAWINGS

FIG. 1 schematically illustrates a system for controlling and limiting the pitch angle of the blades of a fan of an aircraft powertrain according to one embodiment;

FIG. 2 is a flowchart illustrating steps of a method for controlling and limiting the pitch angle of the blades of a fan of an aircraft powertrain according to one embodiment;

FIG. 3 illustrates an aircraft comprising an avionics device according to one embodiment; and

FIG. 4 illustrates one example of an internal architecture of an avionics device configured to carry out the method illustrated in FIG. 2.

### DETAILED DESCRIPTION OF EMBODIMENTS

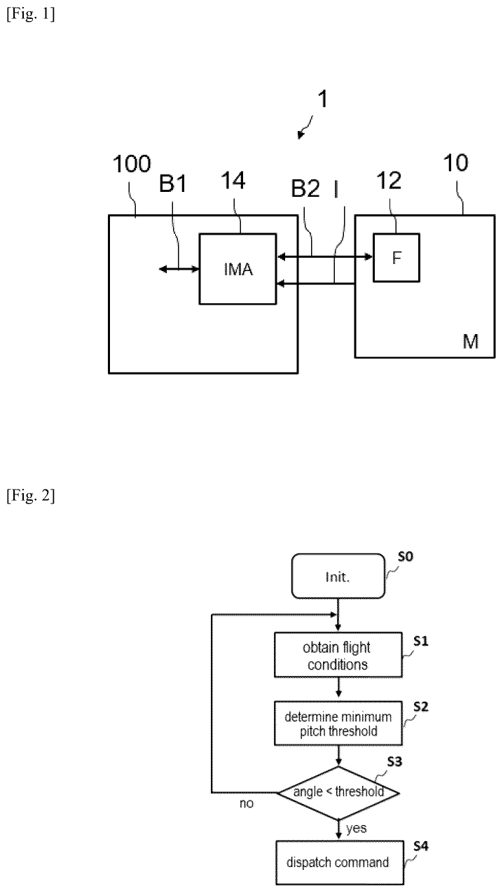

FIG. 1 schematically shows a control system 1 for controlling the pitch angle of the blades of a fan of a powertrain M 10 of an aircraft 100. The control system 1 is installed on board the aircraft 100. The control system 1 comprises an avionics device 14 for controlling and limiting the pitch angle of the blades of the fan. The control system 1 and the avionics control device 14 are independent of the powertrain 10. According to one embodiment, the powertrain 10 is a turbojet powertrain comprising a fan. In a known manner, the powertrain 10 is mounted so as to be integral with the aircraft 100. The powertrain 10 comprises a control device F 12 dedicated to a set of control functions for the powertrain 10, and referred to herein as the “device for controlling the powertrain”. According to one embodiment, the device 12 for controlling the powertrain 10 is a FADEC device (FADEC standing for Full Authority Digital Engine Control). The avionics device 14 is connected to the device 12 for controlling the powertrain 10. The device 12 for controlling the powertrain 10 is configured, among the set of control functions for the powertrain 10, to control the pitch angle of the blades of the fan of the powertrain 10. The pitch angle of the blades is here an angle of orientation of the blades of the fan with respect to the plane of rotation of the fan, which plane is perpendicular to the axis of rotation of the fan. More precisely, the pitch angle of the blades of the fan is an angle between a reference chord of the profile of the blades of the fan and the plane of rotation of the fan. According to one embodiment, the reference chord may be the chord of the profile of a blade in its middle (in the middle of the length of the blade). According to some variants, the reference chord is the chord of the blade profile at another point on the blades. The device 12 for controlling the powertrain 10 is for its part controlled and supervised by the avionics device 14, which is for example an IMA device. For this purpose, the device 12 for controlling the powertrain 10 is connected to the avionics device 14 via a set of connections carrying unidirectional and bidirectional signals, considered globally here to be a communication bus B2. The avionics device 14 is for its part connected to third-party systems of the aircraft 100, comprising for example sensors, actuators and modules for controlling and piloting the aircraft 100, such as avionics computers of the aircraft, via a communication bus B1 that comprises (or carries) a high number of unidirectional and bidirectional signals. Said sensors, actuators and modules for controlling and piloting the aircraft are independent of the powertrain 10. Said modules for controlling and piloting the aircraft, such as avionics computers of the aircraft, are in particular configured to acquire items of information delivered by said sensors and to consequently determine items of information representative of flight conditions of the aircraft in relation to its external environment.

According to one embodiment, the powertrain 10 is configured to deliver, to the avionics device 14, a signal I representative of the current pitch angle of the blades of the fan of the powertrain 10. According to a first alternative, the signal I comes from the device 12 for controlling the powertrain 10. According to another alternative, the signal I comes directly from a sensor delivering a signal representative of the pitch angle of the blades of the fan.

FIG. 2 is a flowchart illustrating a method for controlling the pitch angle of the blades of the fan of the powertrain 10 according to one embodiment of the invention. A first step S0 is an initializing step at the end of which all the circuits, devices and systems of the aircraft useful to operation of the aircraft have been supplied with power, initialized and configured for flight of the aircraft on board which the system 1 for controlling the pitch angle of the blades of a fan is housed. In a step S1, with the aircraft in a take-off, climb, cruise or descent phase, or even in a landing phase, the avionics device 14 regularly and iteratively receives a plurality of items of information representative of flight conditions of the aircraft in relation to its external environment. According to one embodiment, these items of information representative of flight conditions of the aircraft in relation to its external environment comprise the current airspeed of the aircraft, the current ground speed of the aircraft, the current altitude of the aircraft with respect to a reference level (for example sea level), the current air temperature, the current atmospheric pressure at sea level, the current local atmospheric pressure, the current wind force and direction, the current humidity, etc. These examples are not limiting. In a step S2, the avionics device 14 determines, on the basis of at least a speed of the aircraft and an altitude of the aircraft, a threshold value representative of a minimum pitch angle below which the blades of the fan must not be configured. This minimum pitch angle is determined so as to limit the risks of undesirable aerodynamic effects affecting the flight of the aircraft when the aircraft is flying at said altitude at said airspeed, the blades of the fan being configured with this minimum pitch angle. According to one embodiment, this threshold value for the pitch angle of the blades of the fan of the powertrain 10 is determined using one or more tables recorded in a memory accessible to the avionics device 14. According to one embodiment, the one or more tables are stored in a non-volatile memory internal to the avionics device 14 or connected to this device, for example by means of the bus B1. These one or more tables are for example established based on in-flight tests on an aircraft similar to the aircraft 100.

In a step S3, the signal I coming from the powertrain 10 is compared with the threshold value determined in step S2, and if the current pitch angle of the blades of the fan is less than the threshold value, a control signal is sent by the avionics device 14 to the device 12 for controlling the powertrain 10, in a step S4, with a view to preserving (locking) the current pitch angle of the blades of the fan.

According to one embodiment, the locking order sent by the avionics device 14, in step S4, is an order requesting that the device 12 for controlling the powertrain preserve the current pitch angle less than said threshold value, or even said threshold value, as the minimum value of the pitch angle of the blades of the fan, the device 12 for controlling the powertrain then being free to command a higher value while operating as usual.

According to one embodiment, the locking order sent by the avionics device 14, in step S4, is an order requesting that the device 12 for controlling the powertrain 10 preserve the current pitch angle less than said threshold value, or even said threshold value, as a fixed value to be preserved of the pitch angle of the blades of the fan, the device 12 for controlling the powertrain 10 then no longer being free to command a higher value for the pitch angle of the blades of the fan. According to one embodiment, the method then loops back to step S1.

According to one embodiment, a fan is locked (pitch angle of the blades limited or pitch fixed) by the control device 12 of the powertrain 10, after receipt of a control message sent by the avionics device 14. The details of the way in which the pitch angle of the blades of the fan is locked, under control by the control device 12 of the powertrain 10, are not described here insofar as they are not useful to comprehension of the invention. Those skilled in the art of aircraft powertrain control will be able to use known means for locking the pitch angle of the blades of a fan or propeller (via one or more electrical, hydraulic or pneumatic components of the control circuit).

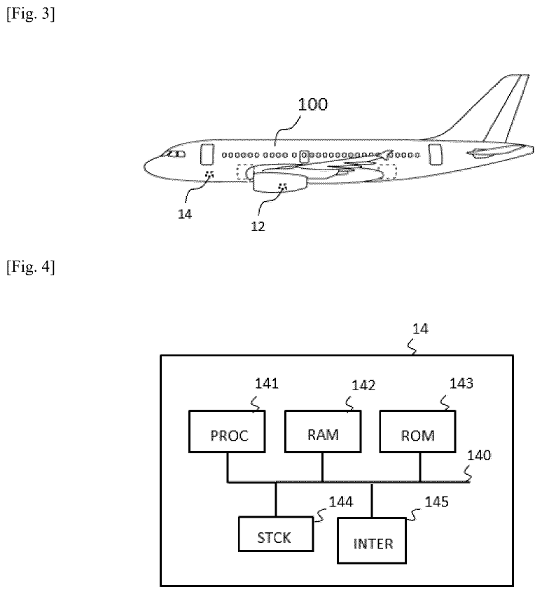

FIG. 3 schematically illustrates the aircraft 100 comprising the avionics device 14 for controlling and limiting, which advantageously allows, through limitation or locking, operations of controlling the pitch angle of the blades of the fan of a powertrain to be made secure, preventing any configuration prejudicial to the flight of the aircraft 100, for example any configuration capable of causing undesirable aerodynamic conditions that will affect the flight of the aircraft.

According to one embodiment, the avionics device 14 is configured to supervise the control of the pitch angle of the blades of a plurality of powertrain fans. Such control of multiple powertrains may advantageously be carried out according to predetermined strategies. For example, one predetermined strategy is such that it is not possible to lock the pitch angle of the blades of all the fans of the powertrains of a given aircraft at the same time. The powertrain control device 12 is also shown in FIG. 3.

FIG. 4 schematically illustrates one example of an internal architecture of the avionics device 14 for controlling and limiting the pitch angle of the blades of a fan of the aircraft 100. The device 14 for controlling and limiting is an avionics device of the aircraft 100.

In the hardware architecture shown by way of example in FIG. 4, the avionics device 14 for controlling and limiting the pitch angle of the blades of a fan comprises the following, connected by a communication bus 140: a processor or central processing unit (CPU) 141; a random-access memory (RAM) 142; a read-only memory (ROM) 143; a storage unit such as a hard disk (or a reader of a storage medium, such as a reader of an SD card, SD standing for Secure Digital) 144; a power and communication interface module 145 allowing the avionics device 14 for controlling and limiting a pitch angle to communicate with remote devices, such as remote sensors, actuators or controllers in particular including one or more controller devices for controlling an aircraft powertrain.

The processor 141 of the avionics device 14 for controlling and limiting pitch angle is capable of executing instructions loaded into the RAM 142 from the ROM 143, from an external memory (not shown), from a storage medium (such as an SD card), or from a communication network. When the avionics device 14 is turned on, the processor 141 is capable of reading instructions from the RAM 142 and of executing them. These instructions form a computer program that causes the processor 141 of the avionics device 14 to implement all or part of a method for controlling the pitch angle of the blades of a fan or propeller, in particular based on obtained items of information representative of a current pitch angle and of flight conditions of the aircraft in question in relation to its external environment.

All or part of such a method for controlling a pitch angle of the blades of a fan or propeller, as illustrated in FIG. 2, may then be implemented in software form via execution of a set of instructions by a programmable machine, for example a digital signal processor (DSP) or a microcontroller, or be implemented in hardware form by a dedicated machine or component, for example a field-programmable gate array (FPGA) or an application-specific integrated circuit (ASIC). In general, the avionics device 14 for controlling and limiting a pitch angle of the blades of a fan or propeller comprises electronic circuitry configured to implement a method for controlling a pitch angle as described. Of course, the avionics device 14 for controlling and limiting a pitch angle further comprises or is coupled to all of the elements usually present in an electronic system comprising a control unit and its peripherals, such as a power supply circuit, a power supply monitoring circuit, one or more clock circuits, a zeroing circuit, input/output ports, interrupt inputs, and bus drivers, this list not being exhaustive.

The control of the pitch angle of the blades of a fan described above applies in the same way to blades of a propeller of an aircraft-propeller powertrain, in particular a turboprop.

1. A method for controlling and limiting a pitch angle of the blades of a fan or propeller of a powertrain of an aircraft, the method being carried out in an avionics device of said aircraft, the avionics device being housed on board the aircraft, being independent of the powertrain and being connected to a control device for controlling said powertrain driving said fan or said propeller, the control device being contained within the powertrain, the method comprising:
obtaining first items of information representative of flight conditions of said aircraft in relation to its external environment, supplied by at least one avionics computer of the aircraft independent of the powertrain, these first items of information comprising at least an altitude and an airspeed of the aircraft,
determining a threshold value for the pitch angle of the blades of said fan or propeller, based on said first items of information, so as to limit the risks of undesirable aerodynamic effects affecting the flight of the aircraft when the aircraft is flying at said altitude at said airspeed,
obtaining an item of information representative of a current pitch angle of the blades of said fan or propeller, and then
sending, to said control device for controlling the powertrain, a control signal when said item of information representative of said current pitch angle of the blades is less than said threshold value, for the purpose of locking the pitch angle of the blades of the fan or propeller, under control by the control device of the powertrain.

2. The method for controlling and limiting a pitch angle of the blades of an aircraft fan or propeller according to claim 1, said control signal aiming to establish said current pitch angle less than the threshold value, or the threshold value, as a minimum value of the pitch angle of the blades, said control device then being free to control a pitch angle of the blades to a pitch angle of the blades of greater value.

3. The method for controlling and limiting a pitch angle of the blades of an aircraft fan or propeller according to claim 1, said control signal aiming to establish said current pitch angle of the blades less than the threshold value, or even the threshold value, as a fixed value to be preserved of the pitch angle of the blades.

4. The method for controlling and limiting a pitch angle of the blades of a fan or propeller according to claim 1, wherein, the avionics device being connected to devices for controlling at least two powertrains of the aircraft, the avionics device is configured to supervise control of the pitch angle of the blades of fans or propellers of said at least two powertrains and not to command the pitch angle of the fans or propellers of all the powertrains of the aircraft to be locked simultaneously.

5. An avionics device for controlling and limiting a pitch angle of the blades of a fan or propeller of a powertrain of an aircraft, said avionics device being designed to be housed on board the aircraft, independent of the powertrain, and comprising electronic circuitry configured to:
obtain first items of information representative of flight conditions of said aircraft in relation to its external environment, supplied by at least one avionics computer of the aircraft independent of the powertrain, these first items of information comprising at least an altitude and an airspeed of the aircraft,
determine a threshold value for the pitch angle of the blades of said fan or propeller, based on said first items of information, so as to limit the risks of undesirable aerodynamic effects affecting the flight of the aircraft when the aircraft is flying at said altitude at said airspeed,
obtain an item of information representative of a current pitch angle of the blades of said fan or propeller, and
send, to said control device for controlling the powertrain, a control signal when said item of information representative of said current pitch angle of the blades is less than said threshold value, for the purpose of locking the pitch angle of the blades of the fan or propeller, under control by the control device of the powertrain.

6. The avionics device for controlling and limiting a pitch angle of the blades of a fan or propeller according to claim 5, wherein the electronic circuitry is configured to supervise control of the pitch angle of the blades of fans or propellers of at least two powertrains of the aircraft and not to command the pitch angle of the fans or propellers of all the powertrains of the aircraft to be locked simultaneously.

7. An aircraft comprising the avionics device for controlling and limiting the pitch angle of blades according to claim 5.

8. (canceled)

9. A non-transitory storage medium comprising a computer program product, for executing the steps of the method according to claim 1 when this program is executed by a processor of a device for controlling and limiting a pitch angle of blades of a propeller or fan.
